(19) United States
(12) Patent Application Publication
(10) Pub. No.: US 2016/0292219 A1
(43) Pub. Date: Oct. 6, 2016

(54) METHOD AND SYSTEM FOR IDENTIFYING TOPICS THAT ARE TRENDING TOGETHER

(71) Applicant: Fanvana Inc., Palo Alto, CA (US)

(72) Inventor: Swetha Prabhakar, Los Altos Hills, CA (US)

(21) Appl. No.: 14/728,212

(22) Filed: Jun. 2, 2015

Related U.S. Application Data
(60) Provisional application No. 62/143,077, filed on Apr. 4, 2015.

(51) Int. Cl. G06F 17/30; H04L 12/26

(52) U.S. Cl. CPC G06F 17/30424; H04L 43/04

(57) ABSTRACT

A method includes determining that a first topic is trending during a particular time period based on monitoring of a plurality of content items published during the particular time period, identifying a first subset of content items that (a) reference the first topic and (b) are published during the particular time period in which the first topic is trending, determining that a second topic is trending within the first subset of content items, and responsive to determining that the second topic is trending within the first subset of the content items, determining that the second topic is associated with a trending of the first topic.

### BENEFIT CLAIM; INCORPORATION BY REFERENCE

This application claims the benefit of U.S. Provisional Patent Application 62/143,077 filed Apr. 4, 2015, which is incorporated herein by reference.

### TECHNICAL FIELD

The present disclosure relates to identifying topics that are trending together. In particular, the present disclosure relates to determining one or more topics associated with the trending of another topic in a plurality of content items published over a trending time period.

### BACKGROUND

Many articles, messages, posts, images, and videos, are being published on various content sources and communications platforms on a daily basis. Many different topics may be referenced in the messages. It may be difficult for users to tell which topics are important, popular, or trending. Furthermore, it may be difficult for users to identify which topics are trending together with other topics.

Some topics may be more frequently referenced than others, and a list of topics may be generated and ranked based on frequency. However, frequency itself may not be a sufficient indicator of importance.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 shows a block diagram example of a system in accordance with one or more embodiments;

FIG. 2 shows a flow chart example of a set of operations for determining that a topic is trending within a particular time period in accordance with one or more embodiments;

FIGS. 3A-3C show an example of determining that a second topic is associated with a trending of a first topic in accordance with one or more embodiments;

FIG. 4 shows a flow chart example of a set of operations for determining that a second topic is associated with the trending of the first topic in accordance with one or more embodiments;

FIGS. 5A-5B show example screenshots for the display of primary trending topics and/or secondary trending topics; and

FIG. 6 shows a block diagram example of a system in accordance with one or more embodiments.

### DETAILED DESCRIPTION

In the following description, for the purposes of explanation, numerous specific details are set forth in order to provide a thorough understanding. One or more embodiments may be practiced without these specific details. Features/components described in one embodiment may be combined with features/components described in a different embodiment. In some examples, well-known structures and devices are described with reference to a block diagram form in order to avoid unnecessarily obscuring the present invention.

General Overview

In one or more embodiments, a first topic is determined to be trending and a second topic is determined to be associated with the trending of the first topic. Determining that the second topic is associated with the trending of the first topic is based on a number of references to the second topic in a set of content items corresponding to the trending of the first topic. The first topic may be referred to herein as a primary trending topic and the second topic (determined to be associated with the trending of the first topic) may be referred to herein as a secondary trending topic corresponding to the primary trending topic. One or more secondary trending topics may be associated with a primary trending topic and the primary topic may, itself, be a secondary topic to some other primary topic. Any type of topic may be found to be trending, such as topics related to sports, politics, and the like. In one example, topics have a tendency to trend together when the topics are related to the same event. For example, when a player LeBron James dunks on another player Jason Terry, users publish content items referring to both LeBron James and Jason Terry. In this example, “LeBron James” may be the primary trending topic and “Jason Terry” may be a secondary trending topic.

In one or more embodiments, determining that any topic is trending includes detecting that a number of references or hits to the topic are increasing amongst a set of content items being published. In one example, a topic is trending if hits of the topic are occurring at a higher frequency, relative to another time period and/or other topics. A hit is a number of times that the topic is referenced, or a number of content items that reference the topic at least once. A trending analysis or criteria applied to a primary trending topic may be different from a trending analysis or criteria applied to a secondary trending topic.

In one or more embodiments, determining that a first topic is trending during a particular time period includes detecting an increase in the number of times the first topic is referenced in a set of content items published during the particular time period. The particular time period is referred to as a trending time period (such as, the last hour, yesterday, the last week, the previous month, and the like). In other embodiments, a set of content items being forwarded, read, liked, and/or streamed over the particular time period are used. In one example, determining that a first topic is trending is based on comparing a frequency with which the topic was referenced in a particular time period to a frequency with which the topic was referenced in one or more preceding time periods. In one example, a topic is trending if a frequency with which the topic is referenced in content items being published over a particular time period is higher than, or statistically significant as compared to, a frequency with which the topic is referenced in content items being published over preceding time periods. A preceding time period may or may not overlap with the particular time period.

In one or more embodiments, determining that a second topic is associated with a trending of a first topic over a particular time period includes detecting an increase in the number of times the second topic is referenced in a set of content items that (a) reference the first topic and (b) are published over the particular time period. The set of content items that (a) reference the first topic and (b) are published over the particular time period reflects or captures a context in which the first topic is trending, such as an event, statement, idea, occurrence, or circumstance related to why or how the first topic is being increasingly referenced. The second topic is referred to herein as trending with or trending together with the first topic.

In one example, determining that a second topic is associated with a trending of the first topic is based on comparing (a) a number of times the second topic is referenced with the first topic with (b) a number of times the second topic is referenced with other topics. In an example, a second topic is determined to be associated with a trending of the first topic if (a) a first frequency with which the second topic and the first topic are referenced together in a set of content items that (i) reference the first topic and (ii) are published during the trending time period, is higher, or statistically significant, as compared to (b) a second frequency with which the second topic and other topics are referenced together in a set of content items that (i) reference the other topics and (ii) are published during the same trending time period.

As another example, determining that a second topic is associated with a trending of the first topic includes processing each of a set of candidate topics based on a rate at which content items referencing the first topic also reference each candidate topic. This rate may be weighted based on another rate at which content items referencing another topic (other than the first topic) also reference the candidate topic. The weighted result may be compared to a threshold value to determine whether the number of content items referencing both the candidate topic and the first topic is statistically significant.

In one or more embodiments, a user interface component is used to display or present a first topic that is trending and a second topic that is associated with the trending of the first topic. In some examples, a user interface concurrently displays (a) a subset of content items that reference a first topic that is trending, and (b) a link to the second topic that is associated with the trending of the first topic. In other examples, a user interface concurrently displays (a) a subset of content items that reference a first topic that is trending, and (b) another subset of content items that reference a second topic that is associated with the trending of the first topic but does not reference the first topic. Other variations for presenting the first topic and the second topic may be used in accordance with one or more embodiments.

A. Architechtural Overview

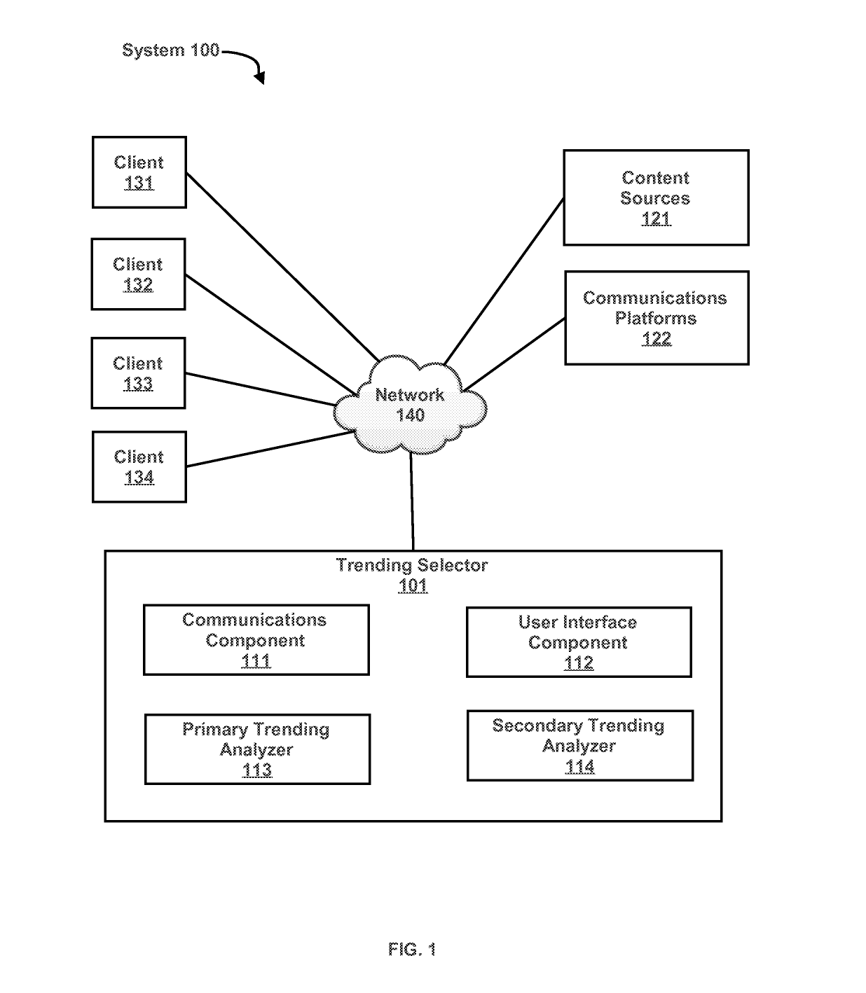

FIG. 1 shows a block diagram example of a system in accordance with one or more embodiments. System 100 includes a trending selector 101, one or more content sources 121, one or more communications platforms 122, clients 131-134, and a network 140. Trending selector 101 includes a communications component 111, a user interface component 112, a primary trending analyzer 113, and a secondary trending analyzer 114. Although a specific system is described, other embodiments are applicable to any system that can be used to perform the functionality described herein. Components described herein may be altogether omitted in one or more embodiments. One or more components described within system 100 may be combined together in a single device or module.

In an embodiment, a content item refers to text, images, video, audio, and/or multimedia. Examples of content items include but are not limited to messages, posts, blog entries on online forums, message boards, social networking sites, photo-sharing sites, video-sharing sites, audio-streaming sites, and/or other mechanisms for digital social interaction.

In an embodiment, a content item references one or more topics. A topic refers to a concept of interest, such as a concept that users may follow, popularly reference, or be interested to read about, that is referenced in a content item. Different types of topics may be used, for example, the names of players (for example, “Kobe Bryant”), the names of sports teams (for example, “Chicago Bulls”), actions of players (for example, “dunk”), and the like. In one example, a topic referenced by a content item is identified by a user (for example, by using a hashtag). In another example, a topic referenced by a content item is identified by a computing system (for example, by using natural language processing, key terms, and the like).

In an embodiment, trending selector 101 determines that a first topic is trending and a second topic is associated with a trending of the first topic based on monitoring a plurality of content items over a particular time period. The content items are transmitted from clients 131-134 for publication on content sources 121 and/or communications platforms 122. Examples of Clients 131-134 include but are not limited to a computer, a laptop, a smartphone, a tablet, or any digital device capable of sending data through network 140. A content source 121 is any source of content, including publications by news outlets, discussions, blogs, books, e-books, printed periodicals, printed publications, official websites of a particular sports team or player, and/or unofficial websites. A communications platform 122 includes any platform enabled by computer hardware and/or software for users to communicate with each other. Examples of the communication platforms include social media platforms, news platforms, discussion platforms, forums, and/or image or video sharing platforms. In an example, a communication platform includes a set of comments by users on an article about a recent win by the San Francisco 49ers. After the content items are transmitted from clients 131-134, the content items are received by trending selector 101 using communications component 111. The content items may be received by trending selector 101 before, simultaneous with, or after the content items are published on content sources 121 and/or communications platforms 122.

In an embodiment, trending selector 101 determines that a first topic is trending and a second topic is associated with a trending of the first topic by analyzing a plurality of content items being published over a particular time period. In one example, primary trending analyzer 113 determines that a first topic is a primary trending topic, and secondary trending analyzer 114 determines that a second topic is a secondary trending topic. One or more secondary trending topics may be associated with a primary trending topic.

In an embodiment, trending selector 101 causes a screen or user interface to present a first topic that is trending along with a second topic that is associated with a trending of the first topic using user interface component 112. In an example, user interface component 112 is a screen that concurrently displays a subset of content items that reference the first topic and a link to the second topic. In another example, a screen concurrently displays a subset of content items that reference the first topic, and another subset of content items that reference the second topic but not the first topic. Trending selector 101 may be local to the screen (for example, reside on the same digital device as the screen) or may be remote from the screen. Trending selector 101 may be implemented or installed in hardware or software, or may be distributed over various hardware or software.

Network 140 may be a Local Area Network, a Wide Area Network, the Internet, Intranet, and the like. As depicted, network 140 is used for exchanging data between clients 131-134, content sources 121, communications platforms 122, and trending selector 101. In other examples, one or more different networks are used to exchange data between these endpoints.

B. Determine that a First Topic is Trending within a Particular Time Period

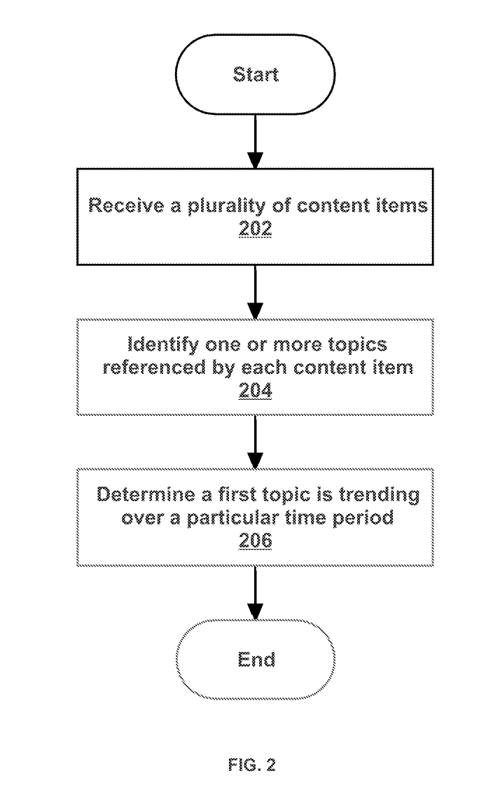

FIG. 2 shows a flow chart example of a set of operations for determining that a topic is trending within a particular time period. Operations as described herein with reference to FIG. 2, may be omitted, rearranged, or modified. Furthermore, operations may be added or performed by different components or devices. Accordingly, the specific set or sequence of operations should not be construed as limiting the scope of any of the embodiments.

Initially, a plurality of content items is received in accordance with one or more embodiments (Operation 202). Receiving the plurality of content items includes communications that are initiated by a source or sender of the content items (for example, data push) and/or communications that are initiated by the trending selector system (for example, data pull). The source of the content items may be a user interface of a client device, a content source, and/or a communications platform. In an example, receiving content items includes scraping one or more content sources for content items. For example, a verified news website is scraped for all articles related to basketball. In another example, receiving content items includes scraping one or more communications platforms for communications published by users. For example, a video sharing website is scraped for all videos uploaded by users that are related to basketball. Comments on the videos, published by users, may also be scraped. Thus content items from a variety of sources (such as content sources and/or communications platforms) may be received.

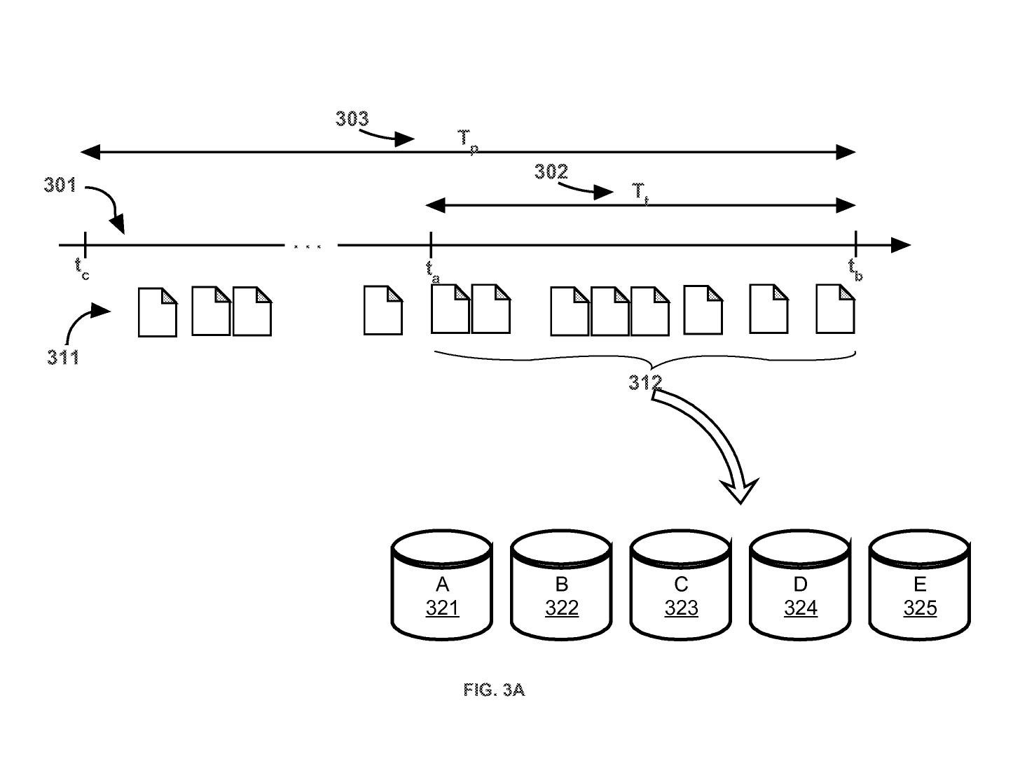

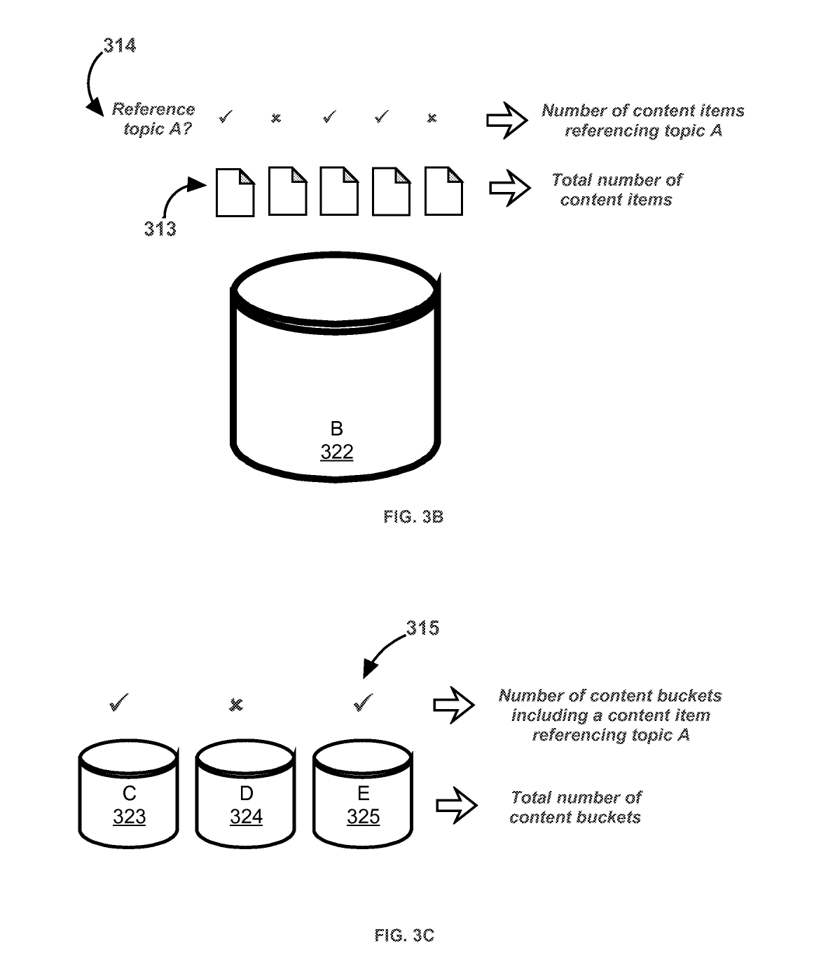

Referring to FIG. 3A, for example, a plurality of content items 311 being received over a timeline 301 is illustrated. Content items 311 may be received before or after, or simultaneous with, the publication of content items 311 on a content source and/or communications platform.

Returning to FIG. 2, one or more topics referenced by each of the content items are identified in accordance with one or more embodiments (Operation 204). In one example, a topic referenced by a content item is identified by a user. In an example, a user includes a hashtag, “#KingJames,” in a content item that a user is posting on a social media platform. Using hashtag matching, a computing system maps this hashtag to a topic, and determines that the content item references the topic, “LeBron James.”

In another example, a topic referenced by a content item is identified by a computing system. In an example, associations between topics may be predetermined or set in a computing system. An association means that if one topic is identified as being referenced by a content item, then another topic associated with that topic is also identified as being referenced by the content item. For example, an association between the topics “LeBron James” and “Cleveland Cavaliers” may be stored in a computing system, reflecting the fact that LeBron James currently plays for the Cleveland Cavaliers. A content item including the hashtag “#KingJames” is identified as referencing the topic “LeBron James” using hashtag matching and also as referencing the topic “Cleveland Cavaliers” using the association between the topics. A topic that is identified as being referenced by a content item may or may not be included within the text of the content item itself.

In another example, a topic referenced by a content item is identified using natural language processing, such as string matching. Natural language processing may determine that the text of a content item includes a key term mapping to a topic. One topic may map to one or more key terms. For example, “Kobe Bryant” may map to key terms “Kobe,” “Bryant,” and his nickname “Black Mamba.” When a content item includes a key term mapping to a topic, then the content item is determined to reference that topic.

As another example, one topic may be associated with one or more stop terms. A stop term stops or reverses a determination that a content item references a particular topic when that determination is made based on a key term. For example, where one key term maps to multiple topics, stop terms are used to determine which of the multiple topics is being referenced. For example, the key term “Melo” maps to two topics, “Carmelo Anthony” and “Romelo Delante Melo Trimble.” Since Carmelo Anthony is an NBA player on the New York Knicks team and Melo Trimble is a college basketball player for the University of Maryland team, “Maryland” and “Trimble” are examples of some stop terms for the topic “Carmelo Anthony.” Thus, a content item referencing “Melo” and “Maryland” may map to “Romelo Delante Melo Trimble,” rather than “Carmelo Anthony.” Still, other ways to map content items to topics may be used.

In another example, a topic referenced by a content item is identified using image processing techniques. For example, a content item is a photo or video that includes an image of a person. The image of the person is compared with template images of basketball players. If a match to a template image of a particular basketball player is found, then the photo or video is identified as referencing the particular basketball player.

In one or more embodiments, a first topic, from the set of topics associated with the plurality of content items, is determined to be trending over a particular time period (Operation 206). The particular time period over which the first topic is trending may be referred to herein as a “trending time period.”

In an embodiment, the first topic is determined to be trending by monitoring and analyzing the received content items. In one example, a topic is determined to be trending during a particular time period if the number of references to the topic in a set of content items published over the particular time period is higher than, or statistically significant as compared to, the number of references to the topic in another set of content items published over a different, representative time period. FIG. 3A, for example, includes a trending time period 302 (running from time tₐ to time t_{b}), a preceding time period 303 (running from time t_{c} to time t_{b}), content items 311, and a subset of content items 312 being published over trending time period 302. A topic is determined to be trending based on a comparison of (a) the number of references to a first topic in content items 312 published over trending time period 302, and (b) the number of references to the first topic in another set of content items published over one or more preceding time periods 303. Trending time period 302 may be short or long, and may be current or in the past (such as, the last hour, yesterday, the last week, the previous month, and the like). Preceding time period 303 may or may not overlap with trending time period 302. Trending time period 302 and preceding time period 303 may be fixed or may dynamically change.

A comparison of (a) the number of references to a first topic in a set of content items published over a particular time period and (b) the number of references to the first topic in another set of content items published over a different time period may be performed in various ways. In one example, a first topic is determined to be trending based on an increase in frequency with which the topic is referenced in content items 312 published during trending time period 302.

In another example, a first topic is determined to be trending based on an increase in a ratio of (a) a number of content items that reference the topic and are published over trending time period 302 to (b) a number of total content items published over trending time period 302 (for example, the number of content items 312).

In another example, a first topic is determined to be trending based at least on a difference between the number of expected hits and the number of observed hits. For example, a number of hits of the first topic in content items published over preceding time period 303 (for example, the last week) is counted or detected. The counted or detected number of hits in a preceding time period is used to determine an expected number of hits in a current time period. In addition, a number of hits of the first topic in content items 312 published over trending time period 302 (for example, the last 30 minutes) is counted or detected, and this number may be normalized to the preceding time period 303. Normalization to the preceding time period 303, may be done, for example, by multiplying (a) the number of hits over trending time period 302 by (b) the duration of preceding time period 303 divided by the duration of trending time period 302 (for example, one week/30 minutes=336). The normalized number is referred to herein as an observed number of hits for the current time period. A first topic is determined to be trending if the difference between the expected number of hits and the observed number of hits is statistically significant. For example, statistical significance is found by comparing the difference to a predetermined threshold value, which can vary based on the type of topic and dynamically adjust based on trends in historical data.

In another example, a first topic is determined to be trending based at least on a difference between the number of expected misses and the number of observed misses. A miss of a topic may refer to a content item that does not reference the topic. For example, a number of misses of the first topic in content items published over preceding time period 303 (for example, the last week) are counted or detected, and this number is referred to herein as an expected number of misses. In addition, a number of misses of the first topic in content items 312 published over trending time period 302 (for example, the last 30 minutes) is counted or detected, and this number is normalized to the preceding time period 303. The normalized number is referred to herein as an observed number of misses.

In an embodiment, a score representing whether and how much a topic is trending is calculated using the expected number of hits, the observed number of hits, the expected number of misses, and the observed number of misses. A first topic may be determined to be trending if a statistical significance is found based on the score. For example, the score is compared to a predetermined threshold value. The threshold value may be static or may dynamically change based on user preference, usage history, historical data, and the like. Statistical significance may also be determined using other statistical models.

Other known or later developed methods for determining that the first topic is trending may be used in accordance with one or more embodiments.

C. Determine that a Second Topic is Associated with the Trending of the First Topic

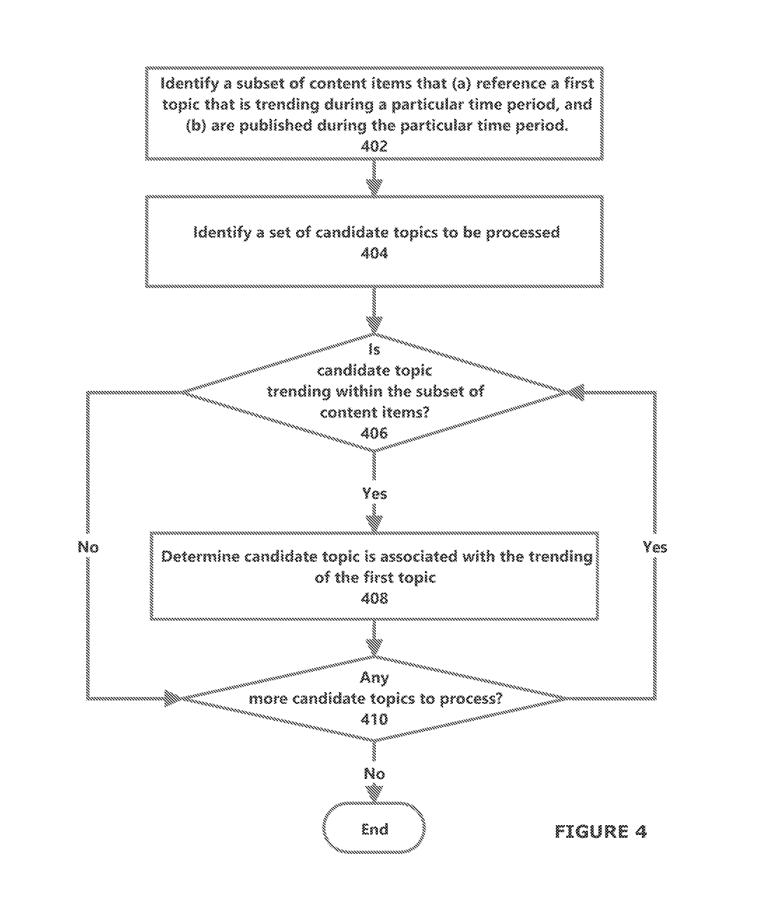

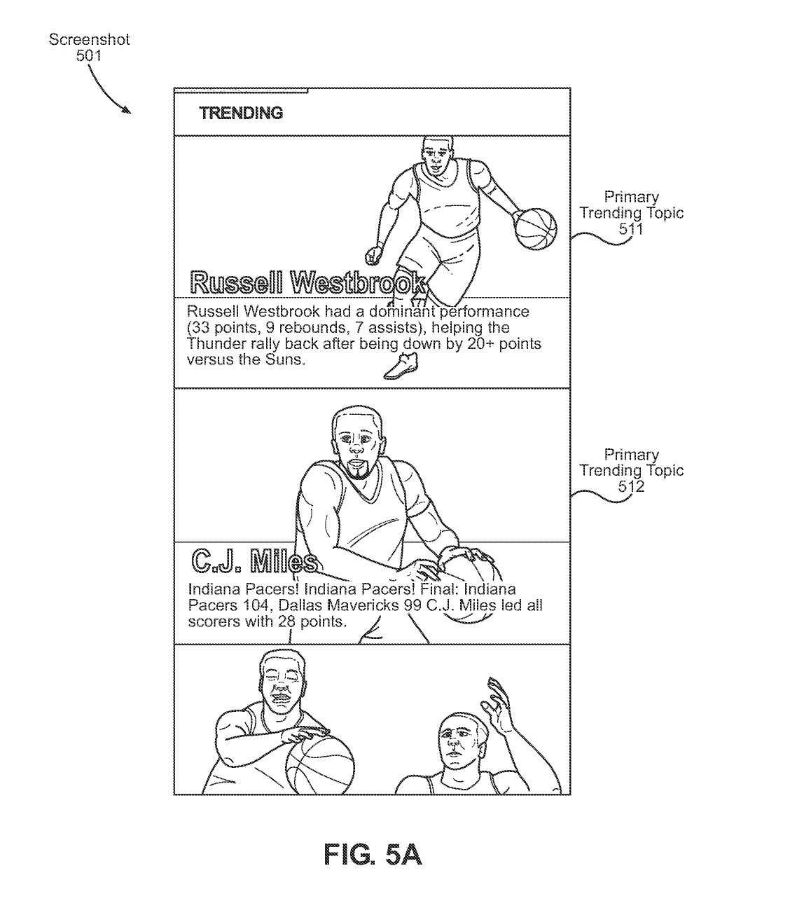

FIG. 4 shows a flow chart example of a set of operations for determining that a second topic is associated with the trending of the first topic. Operations as described herein with reference to FIG. 4, may be omitted, rearranged, or modified. Furthermore, operations may be added or performed by different components or devices. Accordingly, the specific set or sequence of operations should not be construed as limiting the scope of any of the embodiments.

In an embodiment, a second topic is determined to be associated with the trending of the first topic based at least on references to the second topic within a set of content items that (a) reference a first topic that is trending during a particular time period, and (b) are published during the particular time period.

Initially, a plurality of content items are filtered to obtain a particular subset of content items that (a) reference a first topic that is trending during a particular time period, and (b) are published during the particular time period (Operation 402).

FIG. 3A includes groups or content buckets 321-325, each being associated with a different topic. The particular time period in which the first topic is trending may be trending time period 302. Content items 312 published during trending time period 302 may be grouped into content buckets 321-325 based on the topics that are referenced in content items 312. A single content item 312 may be grouped into one or more content buckets 321-325. For example, content bucket 321 may be associated with topic A, and content bucket 322 may be associated with topic B. One content item that references topic A may be grouped into content bucket 321. Another content item that references topic A and topic B may be grouped into content bucket 321 and content bucket 322. Thus, each content bucket 321-325 is associated with a topic, and identifies a subset of content items that reference the associated topic and are published over trending time period 302.

A first subset of content items that (a) reference the first topic and (b) are published over trending time period 302 are filtered into a content bucket associated with the first topic. This subset of content items may reflect or capture a context in which the first topic is trending, such as an event, statement, idea, occurrence, or circumstance related to why or how the first topic is trending.

In one example, content items associated with the trending of “Kobe Bryant” during a particular time period are to be identified. The set of content items include content items that specifically refer to “Kobe Bryant” and content items that refer to aliases for Kobe Bryant such as “Black Mamba.”

Returning to FIG. 4, a set of candidate topics that are to be processed are identified in accordance with one or more embodiments. (Operation 404). In one example, the set of candidate topics may include a pre-defined list of topics. In another example, the set of candidate topics are the topics (other than the first topic) that are referenced by at least one content item within the subset of content items that (a) reference the first topic and (b) are published during the particular time period. Each content item within the subset of content items is analyzed to identify the topics referenced by the content item, if any. As explained above, topics referenced by a content item may be identified by user-defined topics, hashtags, natural language processing, string matching, key terms, stop terms, and the like.

In an embodiment, one of the set of candidate topics is analyzed to determine if the candidate topic is trending within the particular subset of content items (Operation 406). If the candidate topic is trending within the particular subset of content items, then the candidate topic is determined to be trending with the first topic (Operation 408). Subsequently, if additional candidate topics are to be analyzed (Operation 410), the system returns to Operation 406.

Various criteria, comparisons, statistical models, or analyses may be used for determining if a candidate topic is trending with the subset of content items that (a) reference the first topic and (b) are published during the particular time period.

For example, an analysis based on content buckets of different topics may be made. As explained with respect to FIG. 3A, a content bucket 321-325 is associated with a topic, and identifies a subset of content items that (a) reference the associated topic and (b) are published over trending time period 302. In one example, a candidate topic may be associated with a trending of a first topic if a number of content items in the first topic's content bucket that reference the candidate topic is statistically significant compared to a number of content items in the first topic's content bucket that reference a topic other than the candidate topic or the first topic. In another example, a candidate topic may be associated with a trending of a first topic if a number of content items in the first topic's content bucket that reference the candidate topic is statistically significant compared to a number of content items in the content buckets of topics other than the first topic or the candidate topic that reference the candidate topic. Thus, for example, a candidate topic may be found to be associated with a trending of a first topic if the candidate topic is frequently referenced with the first topic, unless the candidate topic is also frequently referenced with other topics.

In some examples, statistical significance for determining whether a candidate topic is associated with a trending of a first topic is based on a rate at which the candidate topic is referenced in the first topic's content bucket. The rate is compared to a predetermined threshold value. For example, if the rate is higher than a threshold value, then the candidate topic is determined to be associated with a trending of the first topic. In one example, the rate equals the number of content items that reference the candidate topic within the first topic's content bucket over the total number of content items in the first topic's content bucket. Referring to FIG. 3B, for example, an inquiry is made as to whether a candidate topic (for example, topic A) is associated with a trending of a first topic (for example, topic B). Content bucket 322 (which is associated with topic B) may include content items 313 that (a) reference the first topic (topic B) and (b) are published over trending time period 302. Each content item 313 is tested to see if the content item 313 references the candidate topic (topic A). The total number of content items in content bucket 322 is determined by counting the number of content items 313. The number of content items that reference the candidate topic within content bucket 322 is determined by counting the number of positive responses from the test results 314.

In some examples, statistical significance for determining whether a candidate topic is associated with a trending of a first topic may further be based on a rate at which the candidate topic is referenced in other topics' content buckets. In one example, the rate at which the candidate topic is referenced in the first topic's content bucket is weighted by a number that represents how often the candidate topic is referenced in other topics' content buckets. The weighted rate is used as a relatedness score representing the relatedness of the candidate topic to the first topic. The relatedness score is compared to a predetermined threshold value. For example, if the relatedness score is lower than a threshold value, then a statistical significance may be found, and the candidate topic is determined to be associated with a trending of the first topic. Referring to FIG. 3C, for example, the total number of content buckets 323-325, excluding the content buckets of the first topic (for example, topic B) and the candidate topic (for example, topic A), is determined. Further, each content bucket 323-325 is tested to see if the content bucket 323-325 includes at least one content item referencing the candidate topic (for example, topic A), and the number of positive responses from the test results 315 is counted. This information is normalized, for example, by taking a logarithm of the total number of content buckets 323-325 over the number of content buckets that reference the candidate topic. The normalized number is used to calculate a relatedness score. Still, other statistical models may be used to determine statistical significance.

In some examples, the following equations may be used:
A=Number of content items in the first topic's content bucket referencing the candidate topic (for example, the number of positive responses in test results 314)
B=Number of content items in the first topic's content bucket (for example, the number of content items 313)
C=Number of content buckets, excluding the content buckets of the first topic and the candidate topic, including at least one content item referencing the candidate topic (for example, the number of positive responses in test results 315)
D=Number of content buckets, excluding the content buckets of the first topic and the candidate topic (for example, the number of content buckets 323-325)

$$Relatedness Score = \frac{A}{B} \times log \frac{D}{C}$$

In some examples, statistical significance for determining whether a candidate topic is associated with a trending of a first topic may be based on comparing a relatedness score to a threshold value. A threshold value may be static or dynamic, and may be set based on user preference, usage history, historical data, and the like. For example, if a user's favorite player is “Kobe Bryant,” then the threshold value used for determining whether a candidate topic is associated with a trending of the topic “Kobe Bryant” may be set such that more candidate topics meet the criteria. As another example, different threshold values may be used in different applications, such as in different sports, in politics, and the like. For example, threshold values may be adjusted according to historical data in each application such that a desired number of candidate topics meeting the criteria may be found. If the relatedness score meets the criteria set by the threshold value, then the candidate topic is determined to be associated with a trending of the first topic, or in other words, related to and dominated by the first topic.

In some examples, how much a candidate topic is associated with a trending of a first topic may be measured by a relatedness score. For example, the lower the relatedness score, the closer the association between the candidate topic and the first topic. If more than one candidate topic is associated with the first topic, the relatedness score may be used to rank the candidate topics by how closely related the candidate topics are to the first topic.

For example, an inquiry may be made as to whether the topic “Kyrie Irving” is related to and dominated by another topic “LeBron James.” In this example, the content bucket of “LeBron James” (that is, the set of content items that reference “LeBron James” and are published over a trending time period for which “LeBron James” is trending) includes 1000 units of content items, wherein 240 of them also reference “Kyrie Irving.” The fraction of content items in LeBron James' content bucket referencing Kyrie Irving is calculated to be 0.240. Further in this example, there are 571 other content buckets in the system, 10 of which include at least one content item reference “Kyrie Irving.” This information is normalized by taking the logarithm of the quotient of the number of other content buckets in the system and the number of content buckets that reference “Kyrie Irving,” which would result in log (571/10)=1.757. In order to determine a weighted representation of Kyrie Irving's relatedness to and dominance by LeBron James, a relatedness score is calculated by multiplying the two values, as follows: 0.240×1.757=0.420. The relatedness score is compared to a threshold value. For example, if the relatedness score is less than an empirically determined threshold, then the result is statistically significant, and “Kyrie Irving” would be determined to be related to and dominated by “LeBron James.” Thus, “Kyrie Irving” is determined to be a secondary trending topic to “LeBron James.”

As described above, the first topic is referred to herein as a primary trending topic, and the second topic that is determined to be trending with the first topic is referred to as a secondary trending topic.

D. Displaying Primary Trending Topics and Secondary Trending Topics

In one or more embodiments, primary trending topics are displayed with data related to secondary trending topics. In one example, a primary trending topic is displayed with a link to one or more secondary trending topics that are trending with the primary trending topic. If multiple secondary trending topics are identified (for example, using operations as described with reference to FIG. 3), the secondary trending topics may be ranked or filtered.

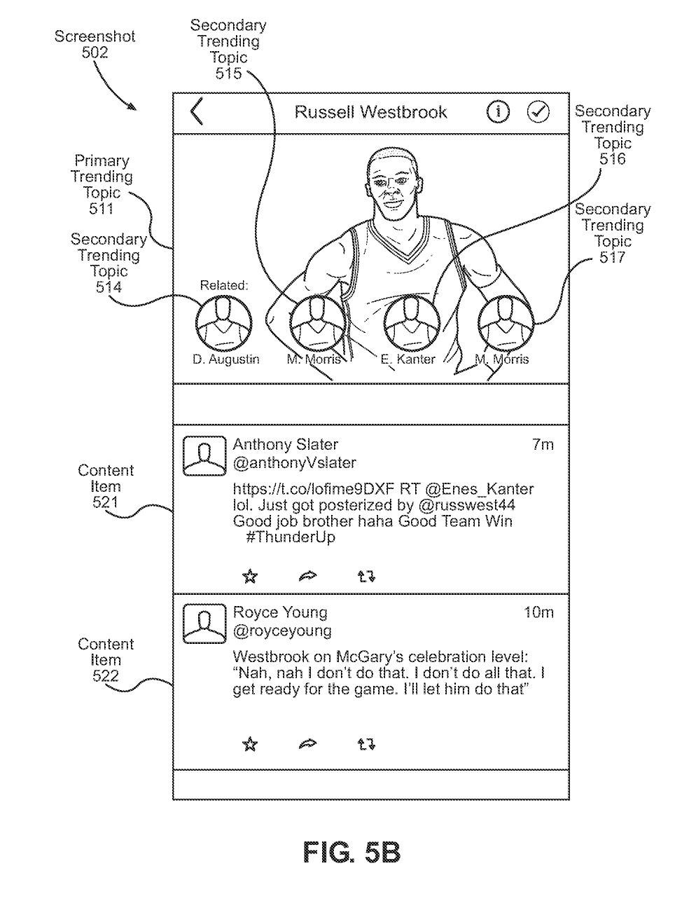

FIGS. 5A and 5B illustrate example screenshots for the display of primary trending topics and/or secondary trending topics. Components illustrated in or described with reference to FIGS. 5A and 5B, may be omitted, rearranged, or modified. Furthermore, components not specifically shown, may be added. Accordingly, the specific set of components should not be construed as limiting the scope of any of the embodiments.

FIG. 5A includes a screenshot 501 showing a list of icons representing primary trending topic 511 (for example, Russell Westbrook) and primary trending topic 512 (for example, C. J. Miles). In some examples, screenshot 501 shows all primary trending topics. In other examples, screenshot 501 shows a subset of the primary trending topics that are trending more than other topics. In other examples, screenshot 501 shows a subset of the primary trending topics that are not also secondary trending topics. When a user clicks or selects one of the icons of primary trending topics (for example, primary trending topic 511), then another screen featuring the selected primary trending topic may be displayed (for example, screenshot 502 illustrated in FIG. 5B).

FIG. 5B includes a screenshot 502 showing an icon representing a selected primary trending topic 511 and other information related to the selected primary trending topic 511. Other information related to primary trending topic 511 may include a set of content items 521-522 that (a) reference primary trending topic 511, and (b) are published over a trending time period of primary trending topic 511. Other information related to primary trending topic 511 may also include one or more secondary trending topics 514-517, which are determined to be associated with a trending of primary trending topic 511. For example, screenshot 502 concurrently displays (a) a first interface component that includes at least a portion of content items 521-522 and (b) a link to a second interface component associated with secondary trending topics 514-517. When a user clicks or selects a link to one of the secondary trending topics 514-517, then another screen featuring the selected secondary trending topic may be displayed. In this example, secondary trending topic 516 refers to E. Kanter. E. Kanter has been determined to be associated with the trending of primary trending topic 511, Russell Westbrook based on references to E. Kanter in content items corresponding to the trending of Russell Westbrook. For example, content item 521 is a comment regarding primary trending topic, Russell Westbrook that references the secondary trending topic, E. Kanter (“Enes_Kanter”).

Further, secondary trending topics 514-517 may be ranked or filtered according to how closely related secondary trending topics 514-517 are to primary trending topic 511. In one example, the most closely related secondary trending topic 514 may be displayed first. In another example, only a subset of the secondary trending topics that are most closely associated with the first topic may be displayed (for example, only four out of ten secondary trending topics may be displayed, the four secondary trending topics being most closely associated with the first topic). In another example, one subset of secondary trending topics may be displayed in one screen orientation, and another subset of secondary trending topics may be displayed in another screen orientation (for example, a larger subset of secondary trending topics may be displayed when in landscape rather than portrait orientation). How closely associated secondary trending topics 514-517 are to primary trending topic 511 may be determined by ranking the relatedness score of each secondary trending topic 514-517, which may be determined in Operation 406.

Still, other ways of selecting, displaying, or presenting a first topic and one or more second topics (associated with a trending of the first topic) may be used. For example, a screen may concurrently display a portion of content items that reference a primary trending topic and a portion of content items that reference a secondary trending topic without referencing the primary trending topic. As another example, a screen may concurrently display a first topic that is trending, a second topic is associated with a trending of the first topic (for example, the second topic is related to and dominated by the first topic), and a third topic wherein the first topic is associated with a trending of the third topic (for example, the first topic is related to and dominated by the third topic).

E. Miscellaneous; Extensions

Embodiments are directed to a system with one or more devices that include a hardware processor and that are configured to perform any of the operations described herein and/or recited in any of the claims below.

In an embodiment, a non-transitory computer readable storage medium comprises instructions which, when executed by one or more hardware processors, causes performance of any of the operations described herein and/or recited in any of the claims.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

F. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

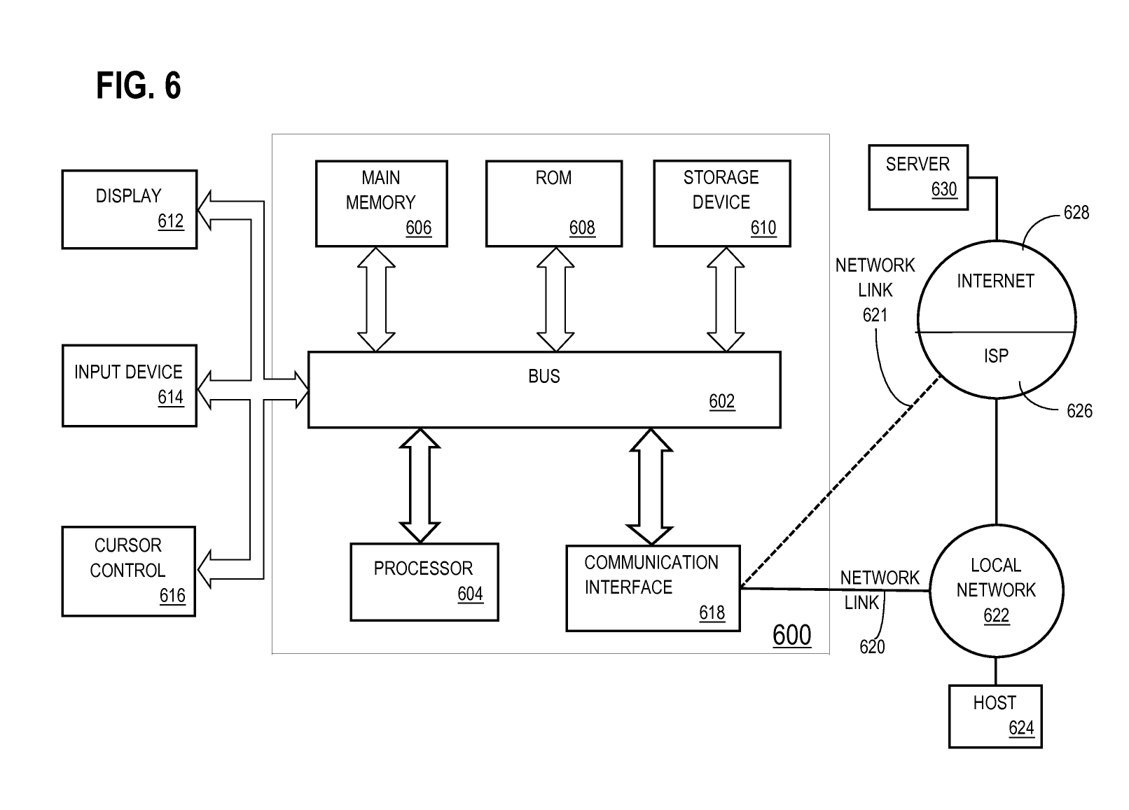

For example, FIG. 6 is a block diagram that illustrates a computer system 600 upon which an embodiment of the invention may be implemented. Computer system 600 includes a bus 602 or other communication mechanism for communicating information, and a hardware processor 604 coupled with bus 602 for processing information. Hardware processor 604 may be, for example, a general purpose microprocessor.

Computer system 600 also includes a main memory 606, such as a random access memory (RAM) or other dynamic storage device, coupled to bus 602 for storing information and instructions to be executed by processor 604. Main memory 606 also may be used for storing temporary variables or other intermediate information during execution of instructions to be executed by processor 604. Such instructions, when stored in non-transitory storage media accessible to processor 604, render computer system 600 into a special-purpose machine that is customized to perform the operations specified in the instructions.

Computer system 600 further includes a read only memory (ROM) 608 or other static storage device coupled to bus 602 for storing static information and instructions for processor 604. A storage device 610, such as a magnetic disk or optical disk, is provided and coupled to bus 602 for storing information and instructions.

Computer system 600 may be coupled via bus 602 to a display 612, such as a cathode ray tube (CRT), for displaying information to a computer user. An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane.

Computer system 600 may implement the techniques described herein using customized hard-wired logic, one or more ASICs or FPGAs, firmware and/or program logic which in combination with the computer system causes or programs computer system 600 to be a special-purpose machine. According to one embodiment, the techniques herein are performed by computer system 600 in response to processor 604 executing one or more sequences of one or more instructions contained in main memory 606. Such instructions may be read into main memory 606 from another storage medium, such as storage device 610. Execution of the sequences of instructions contained in main memory 606 causes processor 604 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage device 610. Volatile media includes dynamic memory, such as main memory 606. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 602. Transmission media can also take the form of acoustic or light waves, such as those generated during radio-wave and infra-red data communications.

Various forms of media may be involved in carrying one or more sequences of one or more instructions to processor 604 for execution. For example, the instructions may initially be carried on a magnetic disk or solid state drive of a remote computer. The remote computer can load the instructions into its dynamic memory and send the instructions over a telephone line using a modem. A modem local to computer system 600 can receive the data on the telephone line and use an infra-red transmitter to convert the data to an infra-red signal. An infra-red detector can receive the data carried in the infra-red signal and appropriate circuitry can place the data on bus 602. Bus 602 carries the data to main memory 606, from which processor 604 retrieves and executes the instructions. The instructions received by main memory 606 may optionally be stored on storage device 610 either before or after execution by processor 604.

Computer system 600 also includes a communication interface 618 coupled to bus 602. Communication interface 618 provides a two-way data communication coupling to a network link 620 that is connected to a local network 622 and coupling to a network link 621 that is connected to Internet Service Provider (ISP) 626. For example, communication interface 618 may be an integrated services digital network (ISDN) card, cable modem, satellite modem, or a modem to provide a data communication connection to a corresponding type of telephone line. As another example, communication interface 618 may be a local area network (LAN) card to provide a data communication connection to a compatible LAN. Wireless links may also be implemented. For example, communication interface 618 may be a hardware network adapter and/or Network Interface Card (NIC) configured for wireless communication such as Wi-Fi, Bluetooth, Edge/2G/3G/4G/LTE, or any other communication protocol known today or later developed. In any such implementation, communication interface 618 sends and receives electrical, electromagnetic or optical signals that carry digital data streams representing various types of information.

Network link 620 and network link 621 typically provide data communication through one or more networks to other data devices. For example, network link 620 may provide a connection through local network 622 to a host computer 624 or to data equipment operated by an Internet Service Provider (ISP) 626. Network link 621 may provide a connection to ISP 626 without going through local network 622. ISP 626 in turn provides data communication services through the world wide packet data communication network now commonly referred to as the “Internet” 628. Local network 622 and Internet 628 both use electrical, electromagnetic or optical signals that carry digital data streams. The signals through the various networks and the signals on network link 620, network link 621, and through communication interface 618, which carry the digital data to and from computer system 600, are example forms of transmission media.

Computer system 600 can send messages and receive data, including program code, through the network(s), network link 620, network link 621 and communication interface 618. In the Internet example, a server 630 might transmit a requested code for an application program through Internet 628, ISP 626, local network 622 and communication interface 618.

The received code may be executed by processor 604 as it is received, and/or stored in storage device 610, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A non-transitory computer readable medium comprising instructions which, when executed by one or more hardware processors, causes performance of operations comprising:
determining that a first topic is trending during a particular time period based on monitoring of a plurality of content items published during the particular time period;
identifying a first subset of content items that (a) reference the first topic and (b) are published during the particular time period in which the first topic is trending;
determining that a second topic is trending within the first subset of content items; and
responsive to determining that the second topic is trending within the first subset of the content items, determining that the second topic is associated with a trending of the first topic.

2. The medium of claim 1, wherein a first criteria used for determining that the first topic is trending is different than a second criteria used for determining that the second topic is trending.

3. The medium of claim 1, wherein determining that the first topic is trending is based at least on detecting an increase in frequency with which the first topic is referenced in the plurality of content items published during the particular time period.

4. The medium of claim 1, wherein determining that the first topic is trending is based at least on detecting an increase in a ratio during the particular time period of (a) a first number of the first subset of content items to (b) a second number corresponding to a total number of the plurality of content items published during the particular time period.

5. The medium of claim 1, wherein determining that the first topic is trending is based at least on detecting a first number of content items in the first subset of content items is statistically significant as compared to a second number of content items that (a) reference the first topic and (b) are published over another time period.

6. The medium of claim 1, wherein determining that the first topic is trending is based at least on:
selecting a second time period that is different from the particular time period;
identifying a second subset of content items that (a) reference the first topic and (b) are published during the second time period;
identifying a third subset of content items that (a) reference one or more topics other than the first topic and (b) are published during the particular time period in which the first topic is trending;
identifying a fourth subset of content items that (a) reference one or more topics other than the first topic and (b) are published during the second time period;
determining a first number of content items in the first subset of content items, a second number of content items in the second subset of content items, a third number of content items in the third subset of content items, and a fourth number of content items in the fourth subset of content items;
detecting a statistical significance of the first number using the first number, the second number, the third number, and the fourth number.

7. The medium of claim 1, wherein determining the second topic is trending within the first subset of content items is based at least on:
detecting that a first number of content items that (a) reference the first topic and the second topic and (b) are published over the particular time period is statistically significant as compared to a second number of content items that (a) reference the first topic and one or more other topics not including the second topic and (b) are published over the particular time period.

8. The medium of claim 1, wherein determining the second topic is trending within the first subset of content items is based at least on:
detecting that a first number of content items that (a) reference the first topic and the second topic and (b) are published over the particular time period is statistically significant as compared to a second number of content items that (a) reference the second topic and one or more other topics not including the first topic and (b) are published over the particular time period.

9. A medium of claim 1, wherein determining the second topic is trending within the first subset of content items is based at least on:
determining a first number of content items in the first subset of content items;
determining a second number of content items that reference the second topic within the first subset of content items; and
calculating a score representing a relatedness of the second topic to the first topic using the first number and the second number.

10. A medium of claim 1, wherein determining the second topic is trending within the first subset of content items is based at least on:
determining a first number of content items in the first subset of content items;
determining a second number of content items that reference the second topic within the first subset of content items;
determining a ratio of the second number to the first number;
grouping one or more content items into one or more subsets, including the first subset, wherein each subset is associated with a topic, and each content item in the subset (a) references the topic with which the subset is associated, and (b) is published over the particular time period;
determining a third number of one or more subsets that (a) are associated with a topic other than the first topic or the second topic and (b) includes one or more content items that references the second topic;
obtaining a score using the ratio of the second number to the first number and the third number; and
detecting that the score is below a threshold value.

11. The medium of claim 1, wherein determining that the second topic is associated with the trending of the first topic comprises determining that the second topic is trending with the first topic.

12. The medium of claim 1, wherein determining that the second topic is associated with the trending of the first topic comprises determining that the first topic and second topic are trending together.

13. The medium of claim 1, wherein the operations further comprise:
identifying the first topic as a primary trending topic; and
identifying the second topic as at least one secondary trending topic corresponding to the primary trending topic.

14. The medium of claim 13, wherein the operations further comprise identifying a third topic as an additional secondary trending topic corresponding to the primary trending topic.

15. The medium of claim 1, wherein the operations further comprise:
responsive to determining that the second topic is associated with the trending of the first topic, concurrently displaying:
(a) a first interface component comprising at least a portion of the first subset of content items that (i) reference the first topic and (ii) are published in the particular time period; and
(b) a link to a second interface component associated with the second topic.

16. The medium of claim 1, wherein the operations further comprise:
responsive to determining that the second topic is associated with the trending of the first topic, concurrently displaying:
(a) at least a portion of the first subset of content items that (i) reference the first topic and (ii) are published in the particular time period; and
(b) at least a portion of a second subset of content items that (i) reference the second topic without referencing the first topic and (ii) are published in the particular time period.

17. The medium of claim 1, wherein the first topic is associated with one or more key terms.

18. A method comprising:
determining that a first topic is trending during a particular time period based on monitoring of a plurality of content items published during the particular time period;
identifying a first subset of content items that (a) reference the first topic and (b) are published during the particular time period in which the first topic is trending;
determining that a second topic is trending within the first subset of content items; and
responsive to determining that the second topic is trending within the first subset of the content items, determining that the second topic is associated with a trending of the first topic;
wherein the method is performed by at least one device including a hardware processor.

19. A system comprising:
at least one device including a hardware processor;
the system being configured to perform operations comprising:
determining that a first topic is trending during a particular time period based on monitoring of a plurality of content items published during the particular time period;
identifying a first subset of content items that (a) reference the first topic and (b) are published during the particular time period in which the first topic is trending;
determining that a second topic is trending within the first subset of content items; and
responsive to determining that the second topic is trending within the first subset of the content items, determining that the second topic is associated with a trending of the first topic.

20. The system of claim 19, wherein a first criteria used for determining that the first topic is trending is different than a second criteria used for determining that the second topic is trending.
